(19) United States
(12) Patent Application Publication
(10) Pub. No.: US 2014/0308524 A1
(43) Pub. Date: Oct. 16, 2014

(54) Stacked Transparent Electrode Comprising Metal Nanowires and Carbon Nanotubes

(71) Applicants: Dae Seob Shim, Uiwang-si (KR); Young Sil Lee, Uiwang-si (KR); Kyoung Tae Youm, Uiwang-si (KR)

(72) Inventors: Dae Seob Shim, Uiwang-si (KR); Young Sil Lee, Uiwang-si (KR); Kyoung Tae Youm, Uiwang-si (KR)

(73) Assignee: Cheil Industries Inc., Gumi-si (KR)

(21) Appl. No.: 14/364,123

(22) PCT Filed: Apr. 24, 2012
(86) PCT No.: PCT/KR2012/003141

§ 371 Date: Jun. 10, 2014

(30) Foreign Application Priority Data
Dec. 20, 2011 (KR) 10-2011-0137888

(51) Int. Cl. H01B 5/14; H01B 1/02; H01B 1/20

(52) U.S. Cl. CPC H01B 5/14; H01B 1/20; H01B 1/02
USPC 428/408

(57) ABSTRACT

The present invention provides a stacked transparent electrode in which a coating layer (B) comprising carbon nanotubes and a coating layer (C) comprising metal nanowires are stacked on a base substrate (A) in a plurality of levels, wherein the stacked structure is composed of the coating layer (B) comprising carbon nanotubes and the coating layer (C) comprising metal nanowires stacked in an alternate manner, further the present invention can maximize the conductivity of the metal nanowire by coating the transparent substrate using the carbon nanotubes and the metal nanowires, and can secure efficiency and stability of the transparent electrode by preventing oxidation of the metal nanowires and maintaining a stable coating surface when coupled with the carbon nanotubes.

### FIELD OF THE INVENTION

The present invention relates to a stacked transparent electrode comprising carbon nanotubes and metal nanowires. More particularly, the transparent electrode having excellent efficiency and stability by stacking coating layer respectively comprising carbon nanotubes and nanosilver wires on a base substrate in an alternate manner, and thus improving electrical conductivity and transparency and improving the antioxidative characteristics of metal nanowires.

### BACKGROUND OF THE INVENTION

Recently, interest on materials for transparent electrodes has been increased, thus technology for thin and light display fields has been accumulatively advanced to become an object of attention.

Films having both electrical conductivity and transparent characteristics are mainly used for the high-tech display devices such as flat panel display and touch screen panels.

Materials as transparent electrodes for such flat display fields have been used by coating metal oxide electrodes such as, conventionally, indium tin oxide (ITO) and indium zinc oxide (IZO) electrodes on glass or plastic substrates through a depositing method such as sputtering. However, transparent electrode films manufactured using the metal oxides have high conductivity and transparency, but low frictional resistance and weak characteristics against bending.

Further, natural reserve for indium used as main materials is limited, thus costs for indium are very high, and indium has poor processibility.

In order to overcome the above-mentioned processibility problem, transparent electrodes using conductive polymer such as polyaniline and polythiophene have been being developed. Transparent electrode films using the conductive polymer have advantages of such as high conductivity due to doping, excellent bondability of coating films, and superior bending characteristics. However, it is difficult for the transparent films using the conductive polymer to obtain excellent electrical conductivity to the extent of being used for transparent electrodes. Also, there is a problem that the transparent films using the conductive polymer have low transparency.

Therefore, carbon nanotubes have been being developed as materials to be compared with the indium tin oxides (ITO). Such carbon nanotubes are used in several fields, and especially development as electrode materials has been being performed based on excellent electrical conductivity of the carbon nanotubes.

Since professor Smalley in Rice University won Novel prize for discover of fullerene on 1996, carbon materials have been stood out as the most outstanding material among structures having nanosizes. If silicone is the core material during 20 centuries, there is a prediction that carbon will be the core material for 21 centuries. Among the carbon, carbon nanotubes are materials that receive high expectations for their industrial application in electronic information communication, environment and energy, and pharmaceutical fields based on the complete material characteristics and structures of the carbon nanotubes. Further, the carbon nanotubes have been expected as major building blocks leading nanoscience from now on.

Carbon nanotubes have graphite sheets in cylinder form with nano-sized diameters and having sp² bond structures. According to the rolling angles and structures of the graphite sheets, the carbon nanotubes show conductive or semiconductive characteristics. Also, the carbon nanotubes are classified into single-walled carbon nanotubes (SWCNT), double-walled carbon nanotubes (DWCNT), multi-walled carbon nanotubes (MWCNT), and rope carbon nanotubes according to the number of bonds forming walls. Especially, the SWCNT having both metallic characteristics and semiconductive characteristics show various electronic, chemical, physical, and optical characteristics, and such characteristics make integrated devices be realized. Application fields of carbon nanotubes, currently under study, are flexible or ordinary transparent electrodes (flexible and/or transparent conductive film), electrostatic dissipation films, field emission devices, planar heating elements, optoelectronic devices, various sensors, transistors, and the like.

Until now, transparent electrodes based on one kind of carbon nanotubes have reported study results adjacent to industrialization, but it is maintained in a laboratory level. Also, silver nanowires, have been recently spotlighted as materials for transparent electrodes, have excellent electrical conductivity and can be coated on flexible substrates, but silver nanowires have insufficient oxidation stability, necessarily, and a polymer overcoating method is applied to the upper layer of the silver nanowires due to haze increase, and thus it is difficult to be applied to commercialized products.

### PURPOSE OF THE INVENTION

The present invention provides transparent electrodes that can have excellent electrical conductivity and transparency.

The present invention also provides transparent electrodes that can have excellent efficiency and stability by improving antioxidation characteristics of metal nanowires.

These and other objects will be achieved by the present invention as described below.

### SUMMARY OF THE INVENTION

In order to overcome the subject, a specific example of the present invention provides a transparent electrode in which a coating layer (B) comprising carbon nanotubes and a coating layer (C) comprising metal nanowires are stacked on a base substrate (A) in a plurality of levels, the stacked transparent electrode can have a stacked structure in which the coating layer (B) comprising carbon nanotubes and the coating layer (B) comprising metal nanowires are stacked in an alternate manner.

Another specific example, the coating layer (B) comprising carbon nanotubes can be coated by applying a carbon nanotube composition comprising 100 parts by weight of a solvent, 0.05 to 1 parts by weight of carbon nanotubes, and 0.05 to 1 parts by weight of a binder resin.

The carbon nanotubes can have an aspect ratio of 1:10 to 1:2000.

The coating layer (C) comprising metal nanowires can be coated by applying with a metal nanowire composition comprising 100 parts by weight of a solvent, 0.05 to 2 parts by weight of metal nanowires, and 0.05 to 1 parts by weight of a binder resin.

The metal nanowires can have an aspect ratio of 1:20 to 1:200.

### EFFECT OF THE INVENTION

The transparent electrode of the present invention has an effect of excellent efficiency and stability in the transparent electrode based on excellent electrical conductivity, transparency, and antioxidation characteristics.

### BRIEF DESCRIPTION OF THE DRAWINGS

FIG. 1 is a schematic drawing of a transparent electrode manufactured by stacking metal nanowire coating layer and carbon nanotube coating layer on a base substrate according to the present invention.

FIG. 2a is a drawing of a scanning electron microscope (SEM) image of a mono-layered transparent electrode composed of a silver nanowire coating layer on a base substrate.

FIG. 2b is a drawing of a scanning electron microscope (SEM) image of a mono-layered transparent electrode composed of a single-walled carbon nanotube coating layer on a transparent substrate.

FIG. 2c is a drawing of a scanning electron microscope (SEM) image of a transparent electrode manufactured by stacking a silver nanowire coating layer and a carbon nanotube coating layer on a base substrate in order according to the present invention.

FIG. 2d is a drawing of a scanning electron microscope (SEM) image of a transparent electrode manufactured by stacking a carbon nanotube coating layer and a metal nanowire coating layer on a base substrate in order according to the present invention.

### DETAILED DESCRIPTION OF THE INVENTION

Hereinafter, the present invention will be specifically described.

Stacked Transparent Electrode

Generally, transparent electrodes require excellent transparency and also excellent electrical conductivity.

The transparent electrode of the present invention comprises a metal nanowire coating layer to secure excellent electrical conductivity such that the transparent electrode can be compared with metal oxides electrodes. However, the metal nanowires can be oxidized by time. If the metal nanowires are oxidized, the electrical conductivity of the transparent electrode can be reduced and the electrode can be corrode and discolored. Thus, the oxidization of the metal nanowires is required to be prevented in order to use the transparent electrode for a long period of time. Further, the metal nanowires have excellent electrical conductivity, but their transparency is reduced. Technical solution is required for both maintaining electrical conductivity and securing transparency when the metal nanowire is used.

The carbon nanotubes have been mainly used as conductive materials, but there is a problem that the carbon nanotubes have insufficient electrical conductivity compared to metal nanowires when the carbon nanotubes are used for transparent electrodes. However, since the carbon nanotubes have comparatively low haze values, it is easy for the carbon nanotubes to secure transparency compared to the metal nanowires. The present inventor intends to obtain advantages of each above-mentioned conductive material at the same time by introducing both carbon nanotubes and metal nanowires as conductive materials. Transparency and conductivity are secured based on a principle that oxidation is prevented by migration of electrons from carbon nanotubes to metal nanowires by difference in work functions of each layer when a metal nanowire coating layer is bonded to a carbon nanotube coating layer.

The transparent electrode of the present invention comprises a coating layer (B) comprising carbon nanotubes and a coating layer (C) comprising metal nanowires on a base substrate (A) based on the above-mentioned technical principle.

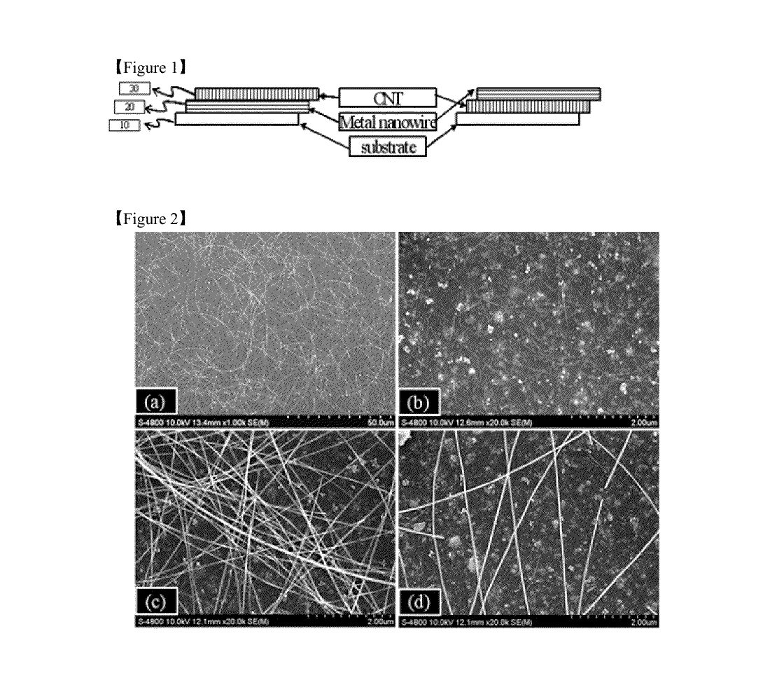

Specifically, referring to the FIG. 1, the transparent electrode of the present invention is characterized by stacking a coating layer (B)(30) comprising carbon nanotubes and a coating layer (C)(20) comprising metal nanowires on a base substrate (A)(10) in a plurality of levels. The stacked structure is characterized by stacking the coating layer (B) comprising carbon nanotubes and the coating layer (C) comprising metal nanowires in an alternate manner. That is, carbon nanotubes and metal nanowires can be coated on the base substrate in a carbon nanotube-metal nanowire order or a metal nanowire-carbon nanotube order, and they can be further coated on the coated surface in an alternate manner. As above, multiple of coating layer (B) comprising carbon nanotubes and coating layer (C) comprising metal nanowires are stacked on a base substrate (A) in an alternate manner to stabilize a network of the transparent electrode so that the electrical conductivity of the transparent electrode can be maximized. When a high content of metal nanowires is included in the transparent electrode, increase of haze value, caused thereby, can reduce.

Further, manufacturing processes are performed by separately stacking the carbon nanotube layer and the metal nanowire layer to secure dispersibility of metal nanowires and prevent mechanical characteristics from reducing by reducing the use of a dispersant and a surfactant at the same time.

Accordingly, the transparent electrode of the present invention has advantages of securing both excellent electrical conductivity and transparency and preventing oxidation compared to one coated with metal nanowires or carbon nanotubes separately.

The transparent electrode of the present invention has preferably a surface resistance of 500 Ω/sq or less, measured using a 4 point-probe method, transmittance of 85% or more, measured with a wavelength of 550 nm using a UV/Vis spectrometer, a haze value of 3.00 or less, preferably 2.00 or less, measured by a haze meter, and a change of preferably 50% or less in surface resistance values, measured after 24 hours under an isothermal-isohumidity condition of temperature of 60° C. and humidity of 90%.

Hereinafter, each coating layer forming the stacked structure of the transparent electrode in the present invention will be specifically described.

(A) Base Substrate

The present invention relates to a transparent electrode, thus a base substrate basically requires transparency. Accordingly, a transparent polymer film or a glass substrate is preferable for the base substrate.

The polymer film can be a polyester-based, polycarbonate-based, polyethersulfone-based, or acryl-based transparent film, specifically can use polyethylene terephthalate (PET), polyethylene naphthalate (PEN), or polyethersulfone (PES).

(B) Carbon Nanotube Coating Layer

Coating layer (B) comprising carbon nanotubes of the present invention can be formed by coating a carbon nanotube composition on a base substrate or a lower coating layer and drying the composition. The carbon nanotube composition includes a solvent, a binder resin, and carbon nanotubes.

Examples of the solvent can include, distilled water, methanol, ethanol, acetone, methyl ethyl ketone, isopropyl alcohol, butyl alcohol, ethylene glycol, polyethylene glycol, tetrahydrofuran, dimethylformamide, dimethylacetamide, hexane, cyclohexanone, toluene, chloroform, dichlorobenzene, dimethylbenzene, pyridine, aniline, or a combination thereof. Preferably using water as a solvent can provide an environmentally friendly manufacturing method. Water is also suggested in terms of environmentally friendly processes.

As the carbon nanotubes, one or more selected among single-walled carbon nanotubes (SWCNT), double-walled carbon nanotubes (DWCNT), multi-walled carbon nanotubes (MWCNT), and rope carbon nanotubes can be used. The carbon nanotubes used for the present invention preferably include at least 90 weight % or more of the single-walled or double walled carbon nanotubes. Further, the carbon nanotubes used for the present invention have preferably an aspect ratio of 1:10 to 1:2000.

The carbon nanotubes can be included in an amount of 0.05 to 1 parts by weight based on 100 parts by weight of the solvent. When the carbon nanotubes less than 0.05 parts by weight are used, a network structure of carbon nanotubes formed after being coated can be vulnerable, and oxidation of metal nanowires is insufficiently prevented. When the carbon nanotubes more than 1 parts by weight are used, transparency of a transparent electrode can be reduced.

A resin which is composed of aqueous anionic atoms and stabilizes coating layers by such as thickening or prevention of phase separation or content deformation is preferably used as the binder resin. Especially, only if the binder resin which controls moisture and stabilizes carbon nanotubes by preventing phase separation and recombination of dispersed carbon nanotubes, the binder resin prevents carbon nanotubes from agglomerating or recombining in a coating process.

Specifically, the binder resin is preferably fluorinated polyethylene introduced with a sulfonyl functional group, in which Nafion, that is fluorine atom, is included, and can use thermoplastic polymer introduced with one or more functional groups selected among carboxylic group, sulfonyl group, phosphonyl group, and sulfone imide group. The functional group can be used in salt form by making one or more groups selected among carboxyl group, sulfonyl group, phosphonyl group, and sulfone imide group be combined with K, Na, and the like. Further, sodium carboxyl methyl cellulose (CMC) and the like can be used.

The binder resin can be included in an amount of 0.05 to 1 parts by weight based on 100 parts by weight of the solvent.

In the specific example of the present invention, the carbon nanotube composition can further include a surfactant.

As an amphiphilic material with hydrophilic and hydrophobic characteristics, the surfactant supports carbon nanotubes to be stably dispersed in an aqueous solution, since the hydrophobic part of the surfactant is affinity to carbon nanotubes and the hydrophilic part thereof is affinity to water, which is a solvent. The hydrophobic part can be composed of a long alkyl chain, and the hydrophilic part can have a sodium salt form. The hydrophobic part of the surfactant in the present invention can use a long chain structure composed of 10 or more carbons, and the hydrophilic part thereof can use both an ionic form and a non-ionic form.

Sodium dodecyl sulfate or sodium dodecyl benzene sulfonate is preferably used as the surfactant. The surfactant can be included in an amount of 0.05 to 1 parts by weight based on 100 parts by weight of a solvent.

(C) Metal Nanowire Coating Layer

The coating layer (C) comprising metal nanowires of the present invention can be formed by coating a metal nanowire composition on a base substrate or a lower coating layer and drying the composition. The metal nanowire composition is composed of a solvent, a binder resin, and metal nanowires.

The metal nanowires are composed of metals selected from the group consisting of silver (Ag), gold (Au), platinum (Pt), tin (Sn), iron (Fe), nickel (Ni), cobalt (Co), aluminum (Al), zinc (Zn), copper (Cu), indium (In), titanium (Ti), and combinations thereof. Among the above, silver nanowires and copper with excellent electrical conductivity are preferably used, and silver nanowires are the most preferable.

Further, the metal nanowires preferably have an aspect ratio of 1:20 to 1:200.

The metal nanowires can be used in an amount of 0.05 to 2 parts by weight based on 100 parts by weight of the solvent. When the metal nanowires less than 0.05 parts by weight are used, the electrical conductivity of the transparent electrode can be reduced. When metal nanowires more than 1 parts by weight are used, the transparency of the transparent electrode can be reduced.

A resin which is composed of aqueous anionic atoms and stabilizes coating layers by such as thickening or prevention of phase separation or content deformation is preferably used as the binder resin. Especially, only if the binder resin which controls moisture and stabilizes carbon nanotubes by preventing phase separation and recombination of dispersed carbon nanotubes, the binder resin prevents carbon nanotubes from agglomerating or recombining in a coating process.

Specifically, the binder resin is preferably fluorinated polyethylene introduced with a sulfonyl functional group, in which Nafion, that is fluorine atom, is included, and can use thermoplastic polymer introduced with one or more functional groups selected among carboxylic group, sulfonyl group, phosphonyl group, and sulfone imide group. The functional group can be used in salt form by making one or more groups selected among carboxyl group, sulfonyl group, phosphonyl group, and sulfone imide group be combined with K, Na, and the like. Further, sodium carboxyl methyl cellulose (CMC) can be used.

The binder resin can be included in an amount of 0.05 to 1 parts by weight based on 100 parts by weight of the solvent. In the specific example of the present invention, the carbon nanotube composition can further include a surfactant.

As an amphiphilic material with hydrophilic and hydrophobic characteristics, the surfactant supports carbon nanotubes to be stably dispersed in an aqueous solution, since the hydrophobic part of the surfactant is affinity to carbon nanotubes and the hydrophilic part thereof is affinity to water, which is a solvent. The hydrophobic part can be composed of a long alkyl chain, and the hydrophilic part can have a sodium salt form. The hydrophobic part of the surfactant in the present invention can use a long chain structure composed of 10 or more carbons, and the hydrophilic part thereof can use both an ionic form and a non-ionic form.

Sodium dodecyl sulfate or sodium dodecyl benzene sulfonate is preferably used as the surfactant. The surfactant can be included in an amount of 0.05 to 1 parts by weight based on 100 parts by weight of the solvent.

### Examples and Comparative Examples

Hereinafter, preferably examples of the present invention are disclosed. The examples below are one preferable example of the present invention, however the present invention is not limited to the below examples.

Preparation of Samples

(1) Base Substrate

A PET film (XU46H of Toray Advanced Materials Korea Inc.) is used, and the transmittance thereof is 93.06%.

(2) Carbon Nanotube Composition

A carbon nanotube composition comprising 100 parts by weight of a DI water solvent, 0.5 parts by weight of a polyacryl-based binder resin, and 0.5 parts by weight of single-walled carbon nanotubes (SWCNT) which is a 210 product of a nanosolution Inc. manufactured by an arc-discharge method is used. The aspect ratio of the carbon nanotubes is 2000.

(3) Metal Nanowire Composition

A composition composed of 100 parts by weight of a DI water solvent, 0.5 parts by weight of a polyacryl-based binder resin, and 1 parts by weight of silver nanowires (Ag NW) of Cambrios Inc. is used. The aspect ratio of the silver nanowires is 130.

Physical Characteristics Evaluation Method (1) Transparency: The transmittance of a transparent conductive film according to the present invention is converted into 100 and is measured with a wavelength of 550 nm using a UV/Vis spectrometer. The haze value thereof is measured using a haze meter (Nippon Denshoku Industries Co. LTD, NHD-5000).

(2) Electrical conductivity: The surface resistance value is measured based on a 4 point-probe method using Mitsubishi Chemical Corporation, Loresta-GP, MCP-T610.

(3) Antioxidation characteristics: Change in surface resistance values is measured under the condition of temperature of 60° C. and humidity of 90% after 24 hours.

### EXAMPLES 1 TO 4

### Example 1

A metal nanowire coating layer is previously formed by applying a silver nanowire (Ag NW) composition diluted to 50% on a PET substrate to be bar-coated, and then washing the bar-coated product. A single-walled carbon nanotube (CNT) composition diluted to 50% is applied on the formed metal nanowire coating layer to be bar-coated, and then the bar-coated product is washed to prepare a stacked transparent electrode. Each of physical characteristics is measured, and the result thereof is shown on a below Table 1.

### Example 2

A stacked transparent electrode is measured based on the same manufacturing method as the Example 1, except that a carbon nanotube coating layer is stacked before a metal nanowire coating layer.

### Example 3

A carbon nanotube coating layer is previously formed by applying a single walled-carbon nanotube (CNT) composition diluted to 50% on a PET substrate to be bar-coated, and then washing the bar-coated product. A stacked transparent electrode is manufactured by applying a silver nanowire (Ag NW) composition diluted to 20% on the carbon nanotube coating layer to be bar-coated, and then washing the bar-coated product.

### Example 4

A stacked transparent electrode is measured based on the same manufacturing method as the Example 3, except that a single-walled carbon nanotube (CNT) composition diluted to 25% and a silver nanowire (Ag NW) composition diluted to 25% are used.

### COMPARATIVE EXAMPLES 1 TO 4

### Comparative Example 1

Physical characteristics of a base substrate without a coating layer are measured. The result thereof is shown on a below Table 2.

### Comparative Example 2

A silver nanowire composition prepared as the dilution ratio of the below Table 2 is bar-coated to manufacture a mono-layered transparent electrode.

### Comparative Example 3

A carbon nanotube composition prepared as the dilution ratio of the below Table 2 is bar-coated to manufacture a mono-layered transparent electrode.

### Comparative Example 4

A mono-layered transparent electrode is manufactured by applying a mixed solution of a single-walled carbon nanotube (CNT) composition diluted to 50% and a silver nanowire (Ag NW) composition diluted to 50% on a PET substrate to be bar-coated, and then washing the bar-coated composition.

TABLE 1

| | | | | Surface |
|---|---|---|---|---|
| | Coating | Transmittance | | resistance |
| Examples | order | (%) | Haze | (Ω/sq) |
| 1 | \textcircled{1} Ag NW 50% | 88.68 | 1.79 | 70 |
| | \textcircled{2} CNT 50% | | | |
| 2 | \textcircled{1} CNT 50% | 89.78 | 1.93 | 47 |
| | \textcircled{2} Ag NW 50% | | | |
| 3 | \textcircled{1} CNT 50% | 89.19 | 1.84 | 260 |
| | \textcircled{2} Ag NW 20% | | | |
| 4 | \textcircled{1} CNT 25% | 91.24 | 2.10 | 128 |
| | \textcircled{2} Ag NW 25% | | | |

TABLE 2

| | | | | Surface |
|---|---|---|---|---|
| Comparative | Dilution | Transmittance | | resistance |
| Examples | ratio | (%) | Haze | (Ω/sq) |
| 1 | RAW | 93.06 | 1.06 | X |
| 2 | Ag NW 10% | 92.62 | 1.90 | X |
| | Ag NW 15% | 92.55 | 1.44 | 2.20K |
| | Ag NW 20% | 92.70 | 1.40 | 1.48K |
| | Ag NW 25% | 92.62 | 1.45 | 120 |
| | Ag NW 30% | 92.08 | 1.69 | 350 |
| | Ag NW 50% | 90.53 | 2.54 | 80 |
| | Ag NW 100% | 78.58 | 8.78 | 6.7 |
| 3 | CNT 10% | 91.83 | 1.83 | 2.34M |
| | CNT 15% | 91.78 | 1.53 | 3.5M |
| | CNT 20% | 92.06 | 1.54 | 812K |
| | CNT 25% | 91.07 | 1.42 | 134K |
| | CNT 30% | 91.58 | 1.61 | 36.8K |
| | CNT 50% | 90.90 | 1.28 | 8.25K |
| | CNT 100% | 90.57 | 1.23 | 5.8K |
| 4 | Mixed solution of | 92.57 | 1.26 | X |
| | Ag NW 50% and | | | |
| | CNT 50% | | | |

TABLE 3

| | | Antioxidation characteristics | | |
|---|---|---|---|---|
| | | Surface | Surface | |
| | | resistance | resistance | |
| | | (Ω/sq) | (Ω/sq) | ^{Δ}Surface |
| | Dilution ratio | (t = 0) | (t = 24 hr) | resistance |
| Example 1 | \textcircled{1} Ag NW 50% | 70 | 93 | 32.9% |
| | \textcircled{2} CNT 50% | | | |
| Example 2 | \textcircled{1} CNT 50% | 47 | 50 | 6.4% |
| | \textcircled{2} Ag NW 50% | | | |
| Comparative | Ag NW 50% | 80 | 140 | 75% |
| Example 2 | | | | |
| Comparative | CNT 50% | 8.25K | 70K | 848% |
| Example 3 | | | | |
| Comparative | Mixed solution of | X | X | X |
| Example 4 | Ag NW 50% and | | | |
| | CNT 50% | | | |

As shown above Table 1, the stacked transparent electrode of the present invention has high transmittance and a low haze value, thereby having excellent transparency, and has a low measured surface resistance value, thereby having excellent electrical conductivity. Further, as shown above Table 3, it can be recognized that multi-layered transparent electrodes have excellent antioxidation characteristics and stability, since difference in surface resistance values of the multi-layered transparent electrode is lower than that of mono-layered transparent electrode after a pre-set period of time under an isothermal-isohumidity condition.

Otherwise, in Tables 2 and 3, the Comparative Example 2 only coated with the metal nanowire coating layer cannot have both electrical conductivity and transparency, and metal nanowires in the Comparative Example 2 are comparatively easily oxidized. It is recognized that Comparative Example 3 only coated with the carbon nanotube coating layer has excellent transparency and has insufficient electrical conductivity required to be used as a transparent electrode. Further, it is recognized that the surface resistance of the Comparative Example 4, the single-layered transparent electrode coated with the mixture of metal nanowires and carbon nanotubes, cannot be measured since dispersibility of the metal nanowires cannot be secured.

Accordingly, the transparent electrode of the present invention has advantages of achieving electrical conductivity, transparency, and antioxidation characteristics at the same time compared to a transparent electrode only coated with metal nanowires or carbon nanotubes.

1. A stacked transparent electrode in which a coating layer (B) comprising carbon nanotubes and a coating layer (C) comprising metal nanowires are stacked on a base substrate (A) in a plurality of levels,
wherein the stacked structure is composed of the coating layer (B) comprising carbon nanotubes and the coating layer (C) comprising metal nanowires stacked in an alternate manner.

2. The stacked transparent electrode of claim 1, wherein the base substrate (A) is a polymer film selected from the group consisting of a polyester-based film, polycarbonate-based film, polyethersulfone-based film, and acryl-based polymer film; or a glass substrate.

3. The stacked transparent electrode of claim 1, wherein the coating layer (B) comprising carbon nanotubes is coated by applying a carbon nanotube composition comprising 100 parts by weight of a solvent, 0.05 to 1 parts by weight of carbon nanotubes, and 0.05 to 1 parts by weight of a binder resin.

4. The stacked transparent electrode of claim 1, wherein the coating layer (C) comprising metal nanowires is coated by applying with a metal nanowire composition comprising 100 parts by weight of a solvent, 0.05 to 2 parts by weight of metal nanowires, and 0.05 to 2 parts by weight of a binder resin.

5. The stacked transparent electrode of claim 3, wherein the carbon nanotube composition further comprises 0.05 to 1 parts by weight of a surfactant.

6. The stacked transparent electrode of claim 1, wherein the carbon nanotubes include in an amount of 90% by weight or more of single-walled or double-walled carbon nanotubes based on the total of the carbon nanotubes.

7. The stacked transparent electrode of claim 1, wherein the carbon nanotubes have an aspect ratio of 1:10 to 1:2000.

8. The stacked transparent electrode of claim 1, wherein the metal nanowires comprise metals selected from the group consisting of silver (Ag), gold (Au), platinum (Pt), tin (Sn), iron (Fe), nickel (Ni), cobalt (Co), aluminum (Al), zinc (Zn), copper (Cu), indium (In), titanium (Ti), and combinations thereof.

9. The stacked transparent electrode of claim 1, wherein the metal nanowires have an aspect ratio of 1:20 to 1:200.

10. The stacked transparent electrode of claim 3, wherein the solvent is selected from the group consisting of distilled water, methanol, ethanol, acetone, methyl ethyl ketone, isopropyl alcohol, butyl alcohol, ethylene glycol, polyethylene glycol, tetrahydrofuran, dimethylformamide, dimethylacetamide, hexane, cyclohexanone, toluene, chloroform, dichlorobenzene, dimethylbenzene, pyridine, aniline, and combinations thereof.

11. The stacked transparent electrode of claim 1, wherein the transparent electrode has transmittance of 85% or more, measured with a wavelength of 550 nm using a UV/Vis spectrometer and a haze value of 3.00 or less, measured using a haze meter.

12. The stacked transparent electrode of claim 1, wherein the transparent electrode has a surface resistance of 500 Ω/sq or less, measured using a 4 point-probe method.

13. The stacked transparent electrode of claim 1, wherein the transparent electrode has a change of 50% or less in surface resistance values, measured after 24 hours under an isothermal-isohumidity condition with temperature of 60° C. and humidity of 90%.

14. The stacked transparent electrode of claim 4, wherein the solvent is selected from the group consisting of distilled water, methanol, ethanol, acetone, methyl ethyl ketone, isopropyl alcohol, butyl alcohol, ethylene glycol, polyethylene glycol, tetrahydrofuran, dimethylformamide, dimethylacetamide, hexane, cyclohexanone, toluene, chloroform, dichlorobenzene, dimethylbenzene, pyridine, aniline, and combinations thereof.
